(19) United States
(12) Patent Application Publication
(10) Pub. No.: US 2008/0216813 A1
(43) Pub. Date: Sep. 11, 2008

(54) BAFFLE PLATE STRUCTURE OF A FAR-INFRARED CORE OF A GRILLER

(76) Inventor: Lucas PAI, Taichung City (TW)

Correspondence Address: EGBERT LAW OFFICES, 412 MAIN STREET, 7TH FLOOR, HOUSTON, TX, 77002, US

(21) Appl. No.: 11/682,203

(22) Filed: Mar. 5, 2007

(51) Int. Cl. A47J 37/06

(52) U.S. Cl. 126/25 R

(57) ABSTRACT

The present invention provides an improved baffle plate structure of a far-infrared core of the griller. The baffle plate is horizontally mounted at regular intervals over the far-infrared core of the existing griller. The baffle plate has a predefined profile, thickness and light transmission property. The baffle plate has a facade in a curved shape forming at least a convex portion and two falling sides. The convex portion faces upwards, and two falling sides of the baffle plate are extended to two predefined positions at both sides of the far-infrared core, thus enabling the baffle plate to cover the top surface of far-infrared core. The convex portion of the curved baffle plate allows oil stains or other foreign materials to be discharged towards two falling sides, thus avoiding the accumulation of foreign materials

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a griller, and more particularly to an innovative baffle plate structure mounted over a far-infrared core of a griller.

2. Description of Related Art Including Information Disclosed Under 37 CFR 1.97 and 37 CFR 1.98

The main objective of the present invention is to provide an improved griller characterized by a far-infrared core. Unlike a common gas core, the far-infrared core has a mesh structure. In the presence of some foreign materials (e.g. oil stains and food residue from roasting), this structure may make it difficult for cleaning, affecting the operational performance. For this reason, a transparent baffle plate 12 is mounted over far-infrared core 11 of the griller 10, as shown in FIG. 1. In such a case, oil stains or food residue dropped from the grill support 13 could be prevented by the baffle plate 12 from falling into the far-infrared core 11, thereby maintaining a clear surface and normal operation.

The following disadvantages are found during the prior art applications.

Since the baffle plate 12 is designed as a plane, either an oil stain or food residue easily accumulates to form a thick oil crust layer, thus blocking off heat radiation from the far-infrared core 11, and leading to poor performance.

Thus, to overcome the aforementioned problems of the prior art, it would be an advancement in the art to provide an improved structure that can significantly improve efficacy.

To this end, the inventor has provided the present invention of practicability after deliberate design and evaluation based on years of experience in the production, development and design of related products.

### BRIEF SUMMARY OF THE INVENTION

The enhanced efficacy of the present invention is as follows:

With the help of a curved baffle plate, the oil stains or other foreign materials are discharged towards two falling sides, thus avoiding the accumulation of oil stains against the heating element of the core.

Moreover, the far-infrared core is expanded to achieve a better heating effect in a broader range.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a sectional view of a typical prior art structure.

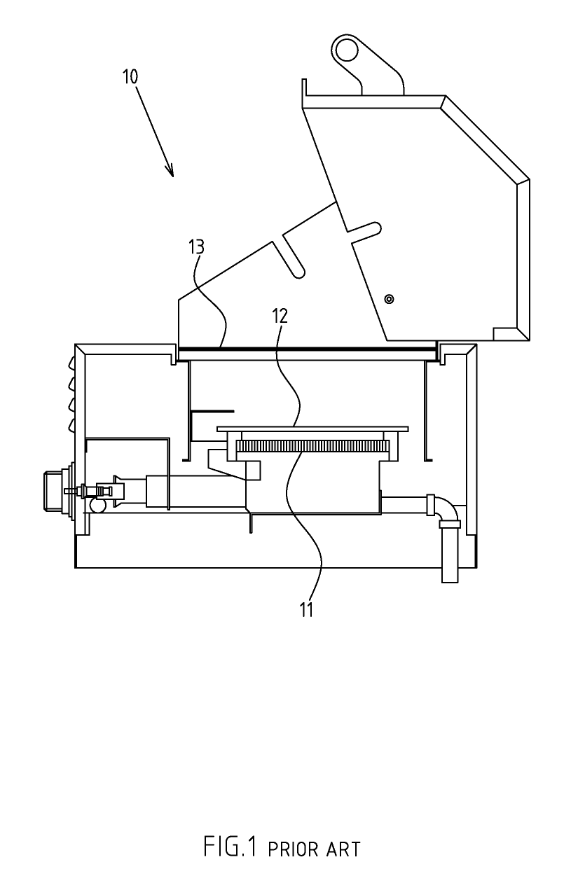

FIG. 2 shows a perspective view of the present invention.

FIG. 3 shows an assembled sectional view of the present invention.

FIG. 4 shows a cross-sectional view of the application of the present invention.

FIG. 5 shows another assembled sectional view of another embodiment of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

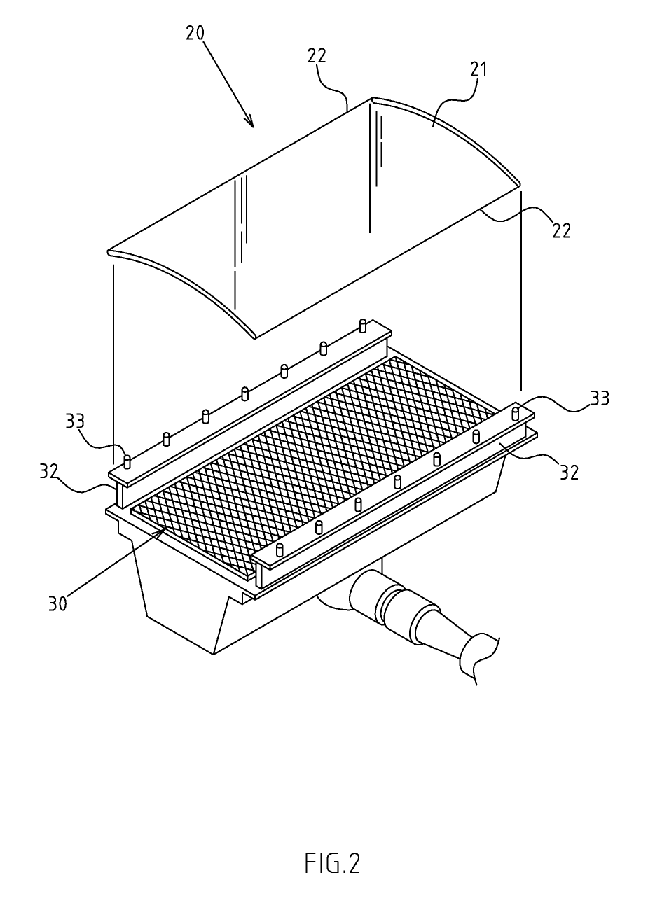

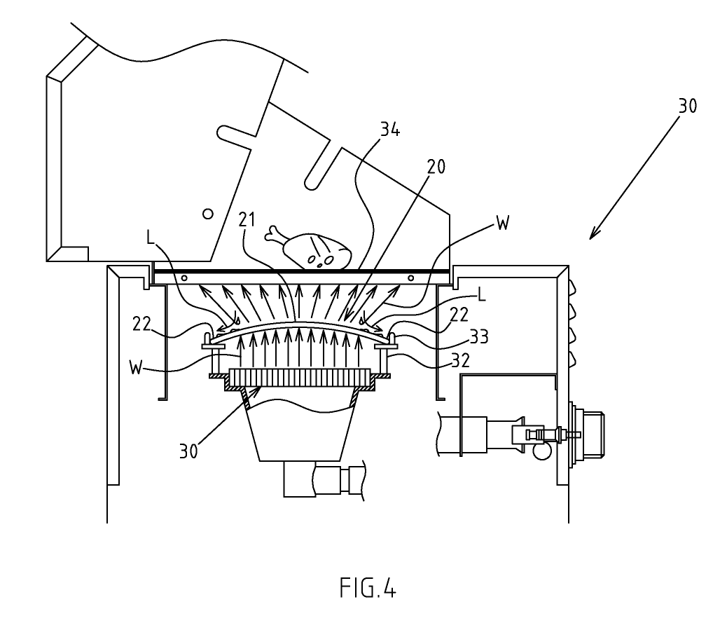

FIGS. 2, 3 and 4 depict preferred embodiments of improved baffle plate structure of the far-infrared griller core of the present invention, which, however, are provided for only explanatory purposes. The baffle plate 20 is horizontally mounted at regular intervals over the far-infrared core 31 of existing griller 30 (shown in FIG. 4). The baffle plate 20 has a predefined profile, thickness and light transmission property, for example, being made of transparent glass.

A feature of the present invention is the facade of the baffle plate 20, having a curved shape forming at least a convex portion 21 and two falling sides 22. The convex portion 21 faces upwards, and two falling sides 22 of the baffle plate 20 are extended to two predefined positions at both sides of far-infrared core 31, thus enabling the baffle plate 20 to cover the top surface of far-infrared core 31.

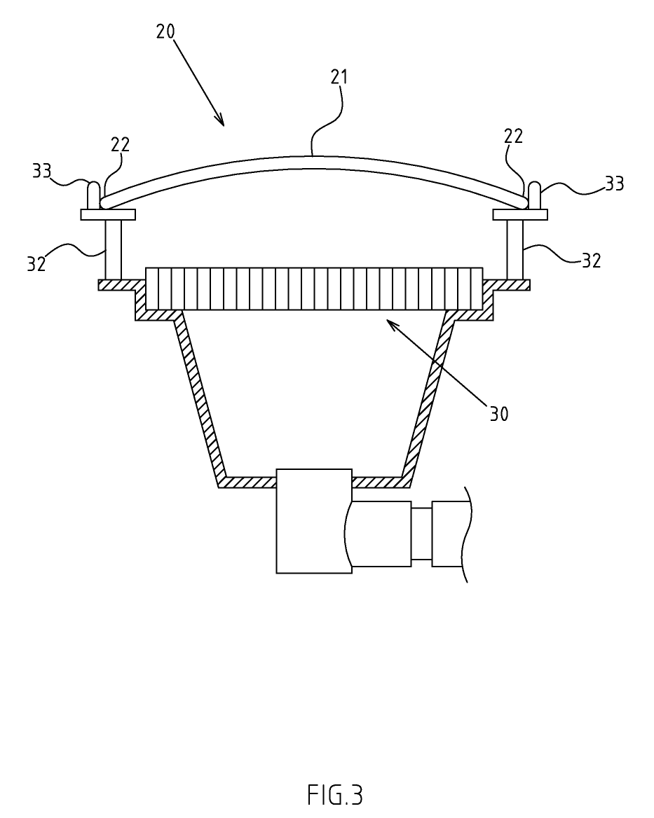

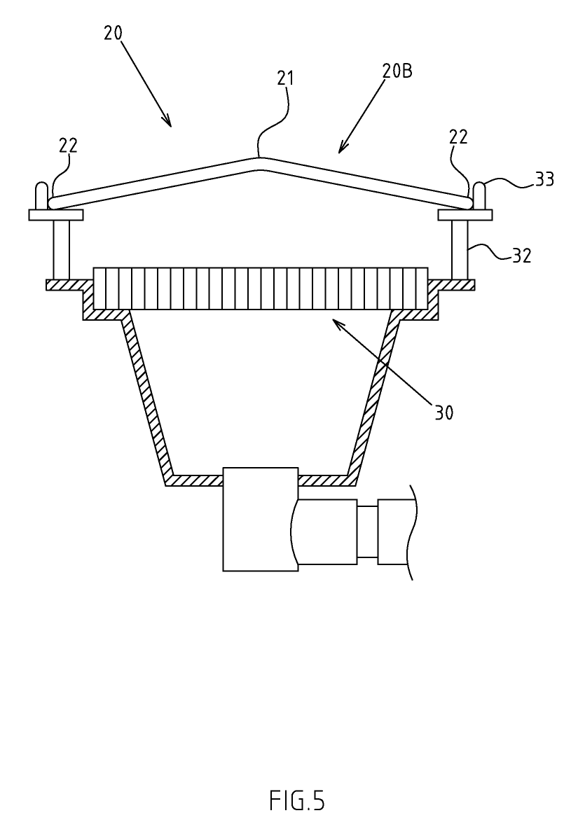

The facade of the baffle plate 20 has a curved shape, as shown in FIG. 3, or an inverted V shape, as shown in FIG. 5 (baffle plate 20B).

At both sides of the top surface of the far-infrared core 31, there is a support frame 32 provided alternatively with limitation convexes, thus serving the objective of positioning the baffle plate.

Based upon above-specified structure, the present invention is operated.

1. A baffle plate structure of a far-infrared core of a griller, said baffle plate structure comprising:
a facade forming at least a convex portion and two falling sides, said convex portion facing upwards, said two falling sides being extended to two predefined positions at both sides of said far-infrared core, said facade covering a top surface of said far-infrared core.

2. The baffle plate structure defined in claim 1, wherein said convex portion is formed by an inverted V-shape.

3. The baffle plate structure defined in claim 1, further comprising:
a support frame is mounted at both sides of said top surface of said far-infrared core, said support frame being provided alternatively with limitation convexes, positioning said facade.

4. The baffle plate structure defined in claim 1, wherein said convex portion is formed by a curved shape.
